(19) United States
(12) Patent Application Publication
(10) Pub. No.: US 2026/0205671 A1
(43) Pub. Date: Jul. 16, 2026

(54) METHOD AND SYSTEM FOR GENERATING REAL-TIME VIDEO CONTENT

(71) Applicant: NEOSAPIENCE, INC., Seoul (KR)

(72) Inventors: Daehan KIM, Seoul (KR); Dam HEO, Seoul (KR); Younggun LEE, Seoul (KR); Taesu KIM, Seoul (KR)

(73) Assignee: NEOSAPIENCE, INC., Seoul (KR)

(21) Appl. No.: 19/166,552

(22) PCT Filed: Aug. 29, 2023
(86) PCT No.: PCT/KR2023/012833

§ 371 Date: Sep. 18, 2025

(30) Foreign Application Priority Data
Nov. 21, 2022 (KR) 10-2022-0156702
Feb. 28, 2023 (KR) 10-2023-0026584

(51) Int. Cl. H04N 21/854; G06F 40/40; G10L 13/027; H04N 21/6437

(52) U.S. Cl. CPC H04N 21/854; G06F 40/40; G10L 13/027; H04N 21/6437

(57) ABSTRACT

The present disclosure is directed to a method of generating real-time video content, performed by at least one processor. The method may include generating text content based on a broadcast outline, generating a first voice based on the text content, generating a first view based on at least one of the text content or the first voice, and transmitting a first video comprising the first voice and the first view in a real-time streaming manner.

### TECHNICAL FIELD

The present disclosure relates to a method and system for generating real-time video content, and more specifically, to a method and system for automatically generating video content broadcast through real-time streaming.

### BACKGROUND ART

With the advancement of science and technology, new media, which are new delivery media not bound by existing mass media such as TV, radio, and newspapers, have emerged. The biggest characteristic difference between existing media and new media is that two-way communication is possible. New media deliver information through communication connections and allow people to share opinions and reactions and discuss various topics.

As an example of new media, real-time streaming broadcasting is showing high growth. Real-time streaming broadcasting is a method of broadcasting that transmits video/audio content in real time to many viewers over the Internet. Real-time streaming broadcasting has the advantage of being able to interact with viewers in real time, such as by reacting in real time to viewers' chats during the broadcast or by reflecting viewers' feedback in the broadcast in real time.

Meanwhile, a host conducting a real-time streaming broadcast must conceive the broadcast content for each broadcast and must conceive lines in real time during the broadcast, which requires skilled techniques for conducting a real-time broadcast. In addition, the host of a real-time streaming broadcast must respond in real time to viewers' reactions while conducting the broadcast and must handle negative or inappropriate chats, but as the number of viewers increases, there is a problem that many human resources are required for this real-time response.

### DETAILED DESCRIPTION OF THE INVENTION

### Technical Problem

The present disclosure provides a method for generating real-time video content, a computer-readable non-transitory recording medium on which instructions are recorded, and an apparatus (system) for solving the above-described problems.

### Technical Solution

The present disclosure may be implemented in various ways, including a method, an apparatus (system), or a computer-readable non-transitory recording medium on which instructions are recorded.

In some embodiments, a method of generating real-time video content, performed by at least one processor, the method may include generating text content based on a broadcast outline, generating a first voice based on the text content, generating a first view based on at least one of the text content or the first voice, and transmitting a first video may include the first voice and the first view in a real-time streaming manner.

In some embodiments, the method further includes acquiring a viewer's real-time chat for the first video transmitted in the real-time streaming manner, and generating reaction text for at least a part of the real-time chat using a chatbot model.

In some embodiments, the method further includes generating a second voice based on the text content and the reaction text, generating a second view based on at least one of the text content or the second voice, and transmitting a second video may include the second voice and the second view in the real-time streaming manner.

In some embodiments, the generating of the reaction text for at least a part of the real-time chat may include generating, using the chatbot model, reaction text associated with broadcast content for at least a part of the real-time chat, based on the broadcast outline or the text content.

In some embodiments, the generating of the reaction text for at least a part of the real-time chat may include selecting one or more real-time chats associated with broadcast content from the real-time chat using a similarity measurement model, and generating the reaction text for the selected one or more real-time chats using the chatbot model.

In some embodiments, the method further includes filtering the real-time chat using a hate-speech detection model configured to determine harmfulness of input text.

In some embodiments, the viewer's real-time chat may include at least one of a text chat, an image chat, a sound chat, or a video chat.

In some embodiments, the generating of the second voice based on the text content and the reaction text may include generating the second voice using a transmission priority associated with the text content and a transmission priority associated with the reaction text.

In some embodiments, the viewer's real-time chat may include a donation chat associated with a donation and a general chat not associated with a donation, the transmission priority associated with the reaction text precedes the transmission priority associated with the text content, and among the reaction text, a transmission priority associated with reaction text for the donation chat precedes a transmission priority associated with reaction text for the general chat.

In some embodiments, the generating of the text content based on the broadcast outline may include generating the text content based on a broadcast outline in a text format using a story generation model.

In some embodiments, the broadcast outline is a song list may include a plurality of song titles, and the generating of the text content based on the broadcast outline may include normalizing the plurality of song titles, collecting information associated with a plurality of songs included in the song list based on the normalized plurality of song titles using a search engine, summarizing the collected information using a summarization model, and changing a style of the summarized information using a style conversion model.

In some embodiments, the broadcast outline is generated based on a collection result of collecting popular search term information using a web that provides at least one of a popular search term service or a trend service.

In some embodiments, the broadcast outline is generated based on a collection result of collecting popular news information using a web that provides news.

In some embodiments, the generating of the text content based on the broadcast outline may include generating, using an image recognition model, the text content based on a broadcast outline in an image format.

In some embodiments, the generating of the text content based on the broadcast outline may include generating, using a voice recognition model, the text content based on a broadcast outline in a sound format.

In some embodiments, the generating of the text content based on the broadcast outline may include generating, using a video recognition model, the text content based on a broadcast outline in a video format.

In some embodiments, the method further includes acquiring a viewer's real-time chat for the first video transmitted in the real-time streaming manner, modifying the broadcast outline based on at least a part of the real-time chat, generating modified text content based on the modified broadcast outline using a story generation model, generating a third voice and a third view based on the modified text content, and transmitting a third video may include the third voice and the third view in a real-time streaming manner.

In some embodiments, the first view may include at least one of a virtual streamer in a character form, a virtual streamer in a virtual person form, or a background view associated with the text content.

In some embodiments, the first view may include a virtual streamer in a character form or a virtual person form, and the generating of the first view based on at least one of the text content or the first voice may include generating the first view may include a facial expression change of the virtual streamer reflecting an emotion associated with the text content, using an emotion prediction model and a facial expression change model.

In some embodiments, the first view may include a virtual streamer in a character form or a virtual person form, and the generating of the first view based on at least one of the text content or the first voice may include generating the first view may include a mouth shape change of the virtual streamer, who is speaking the first voice, using a talking head model.

In some embodiments, the first view may include a virtual streamer in a character form or a virtual person form, and the generating of the first view based on at least one of the text content or the first voice may include generating the first view may include a gesture of the virtual streamer using a gesture model.

In some embodiments, a computer-readable non-transitory recording medium on which instructions for executing the method as claimed in claim 1 on a computer are recorded.

In some embodiments, an information processing system, may include a memory, and at least one processor connected to the memory and configured to execute at least one computer-readable program included in the memory, wherein the at least one program may include instructions for generating text content based on a broadcast outline, generating a first voice based on the text content, generating a first view based on at least one of the text content or the first voice, and transmitting a first video may include the first voice and the first view in a real-time streaming manner.

### Advantageous Effects

According to some embodiments of the present disclosure, because broadcast content is automatically generated and transmitted in real time, and at the same time, an immediate response to viewer reactions is possible, human resources required for conducting real-time broadcasting may be saved.

The effects of the present disclosure are not limited to the effects mentioned above, and other unmentioned effects will be clearly understood by those of ordinary skill in the art to which the present disclosure pertains (“a person of ordinary skill in the art”) from the description of the claims.

### BRIEF DESCRIPTION OF THE DRAWINGS

Embodiments of the present disclosure will be described with reference to the accompanying drawings described below, wherein like reference numerals denote like elements, but are not limited thereto.

FIG. 1 illustrates an example of a method for generating real-time video content according to an embodiment of the present disclosure.

FIG. 2 is a schematic diagram illustrating a configuration in which an information processing system is communicably connected to a plurality of user terminals according to an embodiment of the present disclosure.

FIG. 3 is a block diagram illustrating the internal configuration of a user terminal and an information processing system according to an embodiment of the present disclosure.

FIG. 4 is a block diagram illustrating the internal configuration of a processor of an information processing system according to an embodiment of the present disclosure.

FIG. 5 illustrates an example of generating text content based on a broadcast outline using a story generation model according to an embodiment of the present disclosure.

FIG. 6 illustrates an example of generating text content for a music broadcast based on a broadcast outline including a plurality of song titles according to an embodiment of the present disclosure.

FIG. 7 illustrates an example of generating text content based on a broadcast outline of various modalities according to an embodiment of the present disclosure.

FIG. 8 illustrates an example of generating reaction text for a viewer's real-time chat according to an embodiment of the present disclosure.

FIG. 9 illustrates an example of generating a script based on text content and reaction text according to an embodiment of the present disclosure.

FIG. 10 illustrates an example of generating a voice based on a script and generating a view based on the script and/or the voice according to an embodiment of the present disclosure.

FIG. 11 illustrates an example of generating a view including a virtual streamer based on a script and/or a voice according to an embodiment of the present disclosure.

FIG. 12 illustrates an example of generating a video including a voice and a view and transmitting the video to a viewer according to an embodiment of the present disclosure.

FIG. 13 is a diagram illustrating an artificial neural network model according to an embodiment of the present disclosure.

FIG. 14 is a flowchart illustrating an example of a method for generating real-time video content according to an embodiment of the present disclosure.

### MODE FOR CARRYING OUT THE INVENTION

Hereinafter, specific details for carrying out the present disclosure will be described in detail with reference to the accompanying drawings. However, in the following description, detailed descriptions of well-known functions or configurations will be omitted if there is a risk of unnecessarily obscuring the gist of the present disclosure.

In the accompanying drawings, the same reference numerals are assigned to the same or corresponding components. In addition, in the description of the following embodiments, a repeated description of the same or corresponding components may be omitted. However, even if a description of a component is omitted, the component is not intended to be excluded from any embodiment.

The advantages and features of the disclosed embodiments, and the methods of achieving them, will become clear with reference to the embodiments described below in conjunction with the accompanying drawings. However, the present disclosure is not limited to the embodiments disclosed below and may be implemented in various different forms, and these embodiments are provided only to make the present disclosure complete and to fully inform a person of ordinary skill in the art of the scope of the invention.

The terms used in this specification will be briefly described, and the disclosed embodiments will be described in detail. The terms used in this specification have been selected from currently widely used general terms as much as possible, taking into account the functions in the present disclosure, but the terms may vary depending on the intention of a person skilled in the relevant field, legal precedent, the emergence of new technologies, and so on. In addition, in specific cases, there are also terms arbitrarily selected by the applicant, and in this case, the meaning will be described in detail in the corresponding description of the invention. Therefore, the terms used in the present disclosure should be defined based on the meaning of the terms and the overall content of the present disclosure, not just the names of the terms.

The singular form in this specification includes the plural form unless the context clearly indicates otherwise. In addition, the plural form includes the singular form unless the context clearly indicates otherwise. Throughout the specification, when a certain part is said to “include” a certain component, it means that the certain part may further include other components, rather than excluding other components, unless there is a specific statement to the contrary.

In addition, the term ‘module’ or ‘unit’ used in the specification means a software or hardware component, and the ‘module’ or ‘unit’ performs certain roles. However, the ‘module’ or ‘unit’ is not limited in meaning to software or hardware. A ‘module’ or ‘unit’ may be configured to be in an addressable storage medium and may be configured to reproduce one or more processors. Therefore, as an example, a ‘module’ or ‘unit’ may include components such as software components, object-oriented software components, class components, and task components, and at least one of processes, functions, attributes, procedures, subroutines, segments of program code, drivers, firmware, microcode, circuits, data, databases, data structures, tables, arrays, or variables. The functions provided within the components and ‘modules’ or ‘units’ may be combined into a smaller number of components and ‘modules’ or ‘units’ or may be further separated into additional components and ‘modules’or ‘units’.

According to an embodiment of the present disclosure, a ‘module’ or ‘unit’ may be implemented with a processor and a memory. A ‘processor’ should be broadly interpreted to include a general-purpose processor, a central processing unit (CPU), a microprocessor, a digital signal processor (DSP), a controller, a microcontroller, a state machine, and so on. In some circumstances, a ‘processor’ may also refer to an application-specific integrated circuit (ASIC), a programmable logic device (PLD), a field programmable gate array (FPGA), and so on. A ‘processor’ may also refer to a combination of processing devices, such as, for example, a combination of a DSP and a microprocessor, a combination of a plurality of microprocessors, a combination of one or more microprocessors combined with a DSP core, or any other such configuration. In addition, a ‘memory’ should be broadly interpreted to include any electronic component capable of storing electronic information. A ‘memory’ may also refer to various types of processor-readable media such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage devices, registers, and so on. A memory is said to be in electronic communication with a processor if the processor can read information from and/or write information to the memory. A memory integrated into a processor is in electronic communication with the processor.

In the present disclosure, a ‘system’ may include at least one of a server device and a cloud device, but is not limited thereto. For example, a system may be configured with one or more server devices. As another example, a system may be configured with one or more cloud devices. As yet another example, a system may be configured with a server device and a cloud device operating together.

In the present disclosure, a ‘machine learning model’ may include any model used to infer an answer for a given input. According to an embodiment, a machine learning model may include an artificial neural network model including an input layer, a plurality of hidden layers, and an output layer. Here, each layer may include a plurality of nodes. In the present disclosure, a machine learning model may refer to an artificial neural network model, and an artificial neural network model may refer to a machine learning model. In the present disclosure, a content generator (for example, a story generation model, a summarization model, an image recognition model, a voice recognition model, a video recognition model, etc.), a hate-speech filter, a similarity measurement model, a content chatbot, a voice synthesizer, a view synthesizer (for example, an emotion prediction model, a facial expression change model, a talking head model, a gesture model, etc.) and so on may be implemented as a machine learning model. According to an embodiment, a machine learning model may be run on a server including a GPU for fast inference, and may exchange communications with a client using a REST API.

In the present disclosure, a ‘display’ may refer to any display device associated with a computing device, for example, any display device that can display any information/data controlled by or provided from a computing device.

In the present disclosure, ‘each of a plurality of A's’ or ‘each of a plurality of A’ may refer to each of all components included in the plurality of A's, or may refer to each of some components included in the plurality of A's.

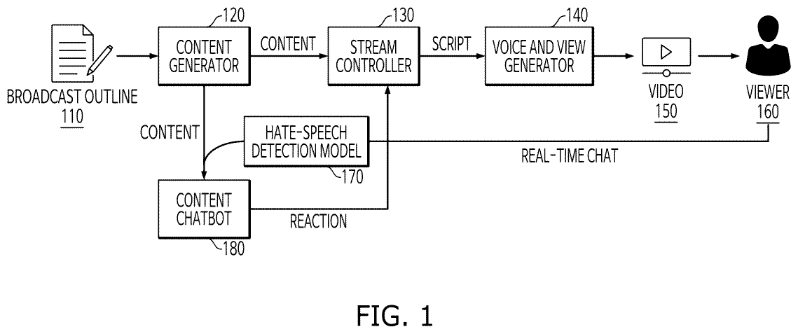

FIG. 1 illustrates an example of a method for generating real-time video content according to an embodiment of the present disclosure. An information processing system may automatically generate video content under the management of a first user (for example, an administrator of a real-time streaming broadcast, hereinafter, an administrator) and transmit the video content in a real-time streaming manner. Additionally, the information processing system may respond immediately to a real-time chat from a second user (for example, a viewer of a real-time streaming broadcast, hereinafter, a viewer 160) regarding the video content transmitted in the real-time streaming manner.

According to an embodiment, a broadcast outline 110 may be given by an administrator. For example, an administrator may input the broadcast outline 110, which is a general outline of the broadcast content, through an administrator terminal, and an information processing system may receive the broadcast outline 110 from the administrator terminal.

Additionally or alternatively, the broadcast outline 110 may be one that is automatically generated based on an information collection result (for example, a crawling result) using the web. For example, the broadcast outline 110 may be one that is generated based on a collection result of collecting popular search term information and/or popular news information using the web. The process of collecting popular search term information or popular news information using the web and/or the process of generating the broadcast outline 110 based thereon may be performed by an information processing system and/or a user terminal (for example, an administrator terminal).

The information processing system may generate text content based on the broadcast outline 110 using a content generator 120. For example, the information processing system may generate text content for a story broadcast based on the broadcast outline 110 in a text format using a story generation model.

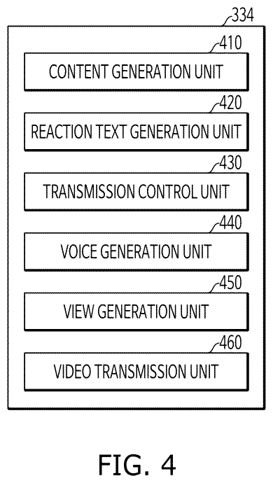

According to an embodiment, the broadcast outline 110 may be of various types, such as a broadcast outline in a text format, a broadcast outline in a sound format, a broadcast outline in an image format, a broadcast outline in a video format, or a combination of at least some of these. The information processing system may generate text content using a separate content generator 120 that is configured differently or trained differently, depending on the type or format of the broadcast outline 110. A specific example of the information processing system generating text content based on the broadcast outline 110 will be described in more detail later with reference to FIGS. 4 to 7.

The generated text content may be included in a script after passing through a stream controller 130. In this process, the administrator may modify the text content to be included in the script. When the text content is modified by the administrator, the modified text content may be included in the script.

The script may include reaction text for real-time chat in addition to the text content. The stream controller 130 may construct the script by considering the transmission priority for the text content and the reaction text, which will be described later after introducing the process in which the information processing system generates reaction text for real-time chat using a content chatbot.

Then, the information processing system may generate a video 150 including a voice and a view using a voice and view generator 140. Here, the voice may include a voice that speaks the script. Also, the view may include at least one of an appearance of a virtual streamer in a character form, an appearance of a virtual streamer in a virtual person form, or a background view associated with the text content. In an embodiment, when the view includes the appearance of a virtual streamer, the view may include a facial expression change of the virtual streamer, a mouth shape change of the virtual streamer, and/or a gesture of the virtual streamer. A specific example of the information processing system generating the video 150 including a voice and a view will be described in more detail later with reference to FIGS. 4 and 10 to 12.

The information processing system may transmit the video 150 including the voice and the view in a real-time streaming manner. A viewer 160 may watch the video 150 broadcast in a real-time streaming manner using a terminal of the viewer 160 and may transmit a real-time chat regarding the video 150. The information processing system may acquire real-time chats regarding the video 150 from a plurality of terminals of the viewer 160.

The information processing system may generate reaction text for at least a part of the real-time chat. First, before generating reaction text for the real-time chat, the information processing system may filter the real-time chat using a hate-speech detection model 170 configured to determine the harmfulness of input text. Then, the information processing system may generate reaction text for the real-time chat.

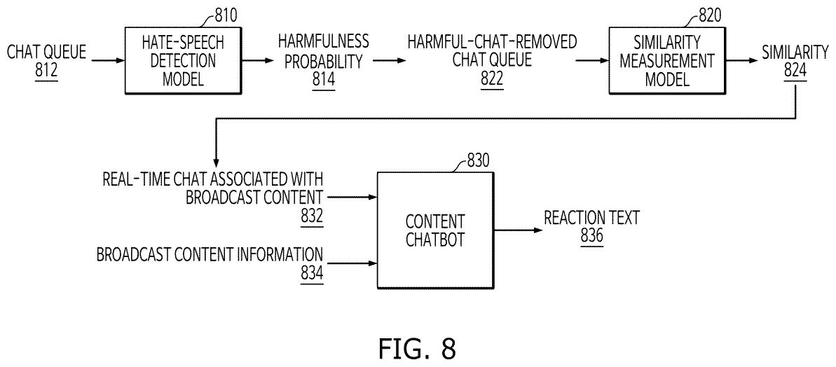

According to an embodiment, instead of simply generating a reaction to a chat based only on the chat, the information processing system may generate reaction text associated with the broadcast content by considering the broadcast outline 110 or the text content using a content chatbot 180. A specific example of the information processing system generating reaction text for a real-time chat will be described in more detail later with reference to FIGS. 4 and 8.

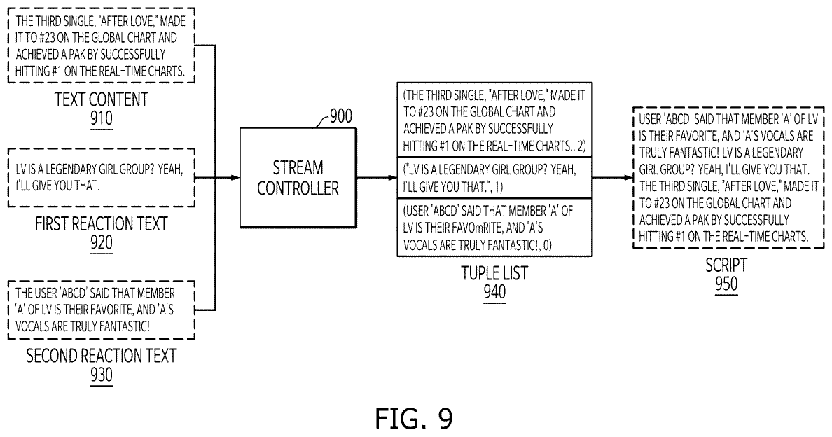

When reaction text is generated, the information processing system may construct a script based on the text content and the reaction text. Specifically, the information processing system may construct the script by considering a transmission priority associated with the text content and a transmission priority associated with the reaction text, using the stream controller 130. In an embodiment, for an immediate response to the real-time chat of the viewer 160, the information processing system may preferentially include the reaction text in the script. That is, the transmission priority associated with the reaction text may precede the transmission priority associated with the text content. A specific example of the information processing system constructing a script using the stream controller 130 will be described in more detail later with reference to FIGS. 4 and 9.

The information processing system may generate a voice and a view using the script constructed based on the text content and the reaction text, and may transmit the video 150 including the voice and the view in a real-time streaming manner.

As described above, because the information processing system can automatically generate broadcast content and transmit the broadcast content in real time while simultaneously responding immediately to the reactions of the viewer 160, human resources required for conducting a real-time broadcast may be saved.

In the above description regarding FIG. 1, for convenience of explanation, it has been assumed and described that the process of generating video content and transmitting the video content in a real-time streaming manner is performed in a predetermined order, but the present disclosure is not limited to the described order. Due to the nature of the real-time streaming manner, at least some of the processes may be performed simultaneously and/or repeatedly.

In addition, in the above description, the method for generating real-time video content has been described as being mainly performed by the information processing system, but the method is not limited thereto, and at least some of the processes included in the method for generating real-time video content of the present disclosure may be performed by a separate device (for example, a user terminal or a separate device for computing assistance, etc.). However, hereinafter, for convenience of explanation, the method for generating real-time video content of the present disclosure will be described assuming that the method is mainly performed by the information processing system.

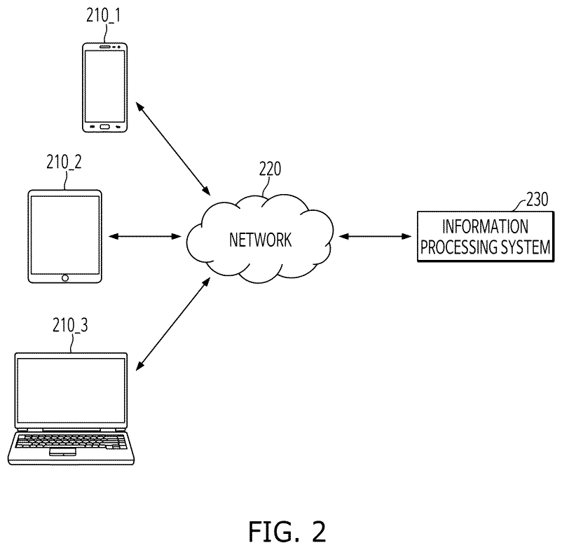

FIG. 2 is a schematic diagram illustrating a configuration in which an information processing system 230 is communicably connected to a plurality of user terminals 210_1, 210_2, and 210_3 according to an embodiment of the present disclosure. As shown, a plurality of user terminals 210_1, 210_2, and 210_3 may be connected via a network 220 to an information processing system 230 that can provide services such as a real-time video content generation service. Here, the plurality of user terminals 210_1, 210_2, and 210_3 may include terminals of users who will be provided with the real-time video content generation service. In an embodiment, the information processing system 230 may include one or more server devices and/or databases that can store, provide, and execute computer-executable programs (for example, downloadable applications) and data related to services such as the real-time video content generation service, or one or more distributed computing devices and/or distributed databases based on a cloud computing service.

The real-time video content generation service provided by the information processing system 230 may be provided to a user through a real-time video content generation application, a real-time broadcast viewing application, a mobile browser application, or a web browser installed on each of the plurality of user terminals 210_1, 210_2, and 210_3. For example, the information processing system 230 may provide information corresponding to a real-time video content generation request, a video content change request, and so on received from the user terminals 210_1, 210_2, and 210_3 through the real-time video content generation application, or may perform corresponding processing.

The plurality of user terminals 210_1, 210_2, and 210_3 may communicate with the information processing system 230 via the network 220. The network 220 may be configured to enable communication between the plurality of user terminals 210_1, 210_2, and 210_3 and the information processing system 230. The network 220 may be configured as a wired network such as Ethernet, a Power Line Communication home network, a telephone line communication device, and RS-serial communication, a wireless network such as a mobile communication network, a Wireless LAN (WLAN), Wi-Fi, Bluetooth, and ZigBee, or a combination thereof, depending on the installation environment. The communication method is not limited, and may include not only communication methods utilizing a communication network that the network 220 may include (for example, a mobile communication network, a wired Internet, a wireless Internet, a broadcasting network, a satellite network, etc.) but also short-range wireless communication between the user terminals 210_1, 210_2, and 210_3.

In FIG. 2, a mobile phone terminal 210_1, a tablet terminal 210_2, and a PC terminal 210_3 are shown as examples of user terminals, but the user terminals are not limited thereto, and the user terminals 210_1, 210_2, and 210_3 may be any computing device capable of wired and/or wireless communication and on which a real-time video content generation application, a mobile browser application, or a web browser can be installed and executed. For example, a user terminal may include an AI speaker, a smartphone, a mobile phone, a navigation system, a computer, a laptop, a digital broadcasting terminal, a Personal Digital Assistant (PDA), a Portable Multimedia Player (PMP), a tablet PC, a game console, a wearable device, an Internet of Things (IoT) device, a virtual reality (VR) device, an augmented reality (AR) device, a set-top box, and so on. In addition, although FIG. 2 shows three user terminals 210_1, 210_2, and 210_3 communicating with the information processing system 230 via the network 220, the present disclosure is not limited thereto, and a different number of user terminals may be configured to communicate with the information processing system 230 via the network 220.

According to an embodiment, the information processing system 230 may receive a broadcast outline from a user terminal 210_1, 210_2, 210_3 (for example, an administrator terminal). Then, the information processing system 230 may generate text content based on the broadcast outline. Then, the information processing system 230 may generate a video including a voice and a view based on the text content, and may transmit the generated video to a plurality of user terminals 210_1, 210_2, 210_3 (for example, viewer terminals) in a real-time streaming manner.

Additionally, the information processing system 230 may acquire a viewer's real-time chat regarding the video. Then, the information processing system 230 may generate reaction text for the real-time chat and may include a voice speaking the reaction text in the video. In addition, the information processing system 230 may transmit the video including the voice speaking the reaction text to the plurality of user terminals 210_1, 220_2, 230_3 in a real-time streaming manner.

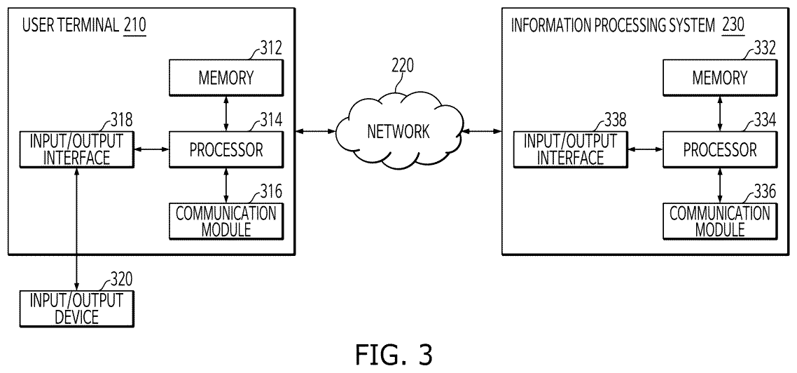

FIG. 3 is a block diagram illustrating the internal configuration of a user terminal 210 and an information processing system 230 according to an embodiment of the present disclosure. The user terminal 210 may refer to any computing device capable of executing a real-time video content generation application, a real-time broadcast viewing application, a mobile browser application, or a web browser, and capable of wired/wireless communication, and may include, for example, the mobile phone terminal 210_1, the tablet terminal 210_2, the PC terminal 210_3, and so on of FIG. 2. As shown, the user terminal 210 may include a memory 312, a processor 314, a communication module 316, and an input/output interface 318. Similarly, the information processing system 230 may include a memory 332, a processor 334, a communication module 336, and an input/output interface 338. As shown in FIG. 3, the user terminal 210 and the information processing system 230 may be configured to communicate information and/or data via a network 220 using their respective communication modules 316 and 336. In addition, an input/output device 320 may be configured to input information and/or data to the user terminal 210 or to output information and/or data generated from the user terminal 210 through the input/output interface 318.

The memories 312 and 332 may include any non-transitory computer-readable recording medium. According to an embodiment, the memories 312 and 332 may include a permanent mass storage device such as a read only memory (ROM), a disk drive, a solid state drive (SSD), a flash memory, and so on. As another example, a permanent mass storage device such as a ROM, an SSD, a flash memory, a disk drive, and so on may be included in the user terminal 210 or the information processing system 230 as a separate permanent storage device distinct from the memory. In addition, an operating system and at least one program code (for example, code for a real-time video content generation application installed on the user terminal 210) may be stored in the memories 312 and 332.

These software components may be loaded from a computer-readable recording medium separate from the memories 312 and 332. Such a separate computer-readable recording medium may include a recording medium that can be directly connected to the user terminal 210 and the information processing system 230, for example, a computer-readable recording medium such as a floppy drive, a disk, a tape, a DVD/CD-ROM drive, a memory card, and so on. As another example, software components may be loaded into the memories 312 and 332 through a communication module rather than a computer-readable recording medium. For example, at least one program may be loaded into the memories 312 and 332 based on a computer program installed by files provided through the network 220 by developers or a file distribution system that distributes installation files for applications.

The processors 314 and 334 may be configured to process instructions of a computer program by performing basic arithmetic, logic, and input/output operations. Instructions may be provided to the processors 314 and 334 by the memories 312 and 332 or the communication modules 316 and 336. For example, the processors 314 and 334 may be configured to execute received instructions according to program code stored in a recording device such as the memories 312 and 332.

The communication modules 316 and 336 may provide a configuration or function for the user terminal 210 and the information processing system 230 to communicate with each other via the network 220, and may provide a configuration or function for the user terminal 210 and/or the information processing system 230 to communicate with another user terminal or another system (for example, a separate cloud system, etc.). For example, a request or data (for example, a text content generation request, a text content modification request, a transmission priority change request, etc.) generated by the processor 314 of the user terminal 210 according to program code stored in a recording device such as the memory 312 may be delivered to the information processing system 230 through the network 220 under the control of the communication module 316. Conversely, a control signal or command provided under the control of the processor 334 of the information processing system 230 may be received by the user terminal 210 through the communication module 316 of the user terminal 210 via the communication module 336 and the network 220. For example, the user terminal 210 may receive text content from the information processing system 230 through the communication module 316.

The input/output interface 318 may be a means for interfacing with the input/output device 320. As an example, an input device may include a camera including an audio sensor and/or an image sensor, a keyboard, a microphone, a mouse, and so on, and an output device may include a device such as a display, a speaker, a haptic feedback device, and so on. As another example, the input/output interface 318 may be a means for interfacing with a device in which a configuration or function for performing input and output is integrated into one, such as a touchscreen. For example, a service screen configured using information and/or data provided by the information processing system 230 or another user terminal when the processor 314 of the user terminal 210 processes instructions of a computer program loaded into the memory 312 may be displayed on a display through the input/output interface 318. In FIG. 3, the input/output device 320 is shown not to be included in the user terminal 210, but the present disclosure is not limited thereto, and the input/output device 320 may be configured as a single device with the user terminal 210. In addition, the input/output interface 338 of the information processing system 230 may be a means for interfacing with a device (not shown) for input or output that is connected to the information processing system 230 or that the information processing system 230 may include. In FIG. 3, the input/output interfaces 318 and 338 are shown as elements configured separately from the processors 314 and 334, but the present disclosure is not limited thereto, and the input/output interfaces 318 and 338 may be configured to be included in the processors 314 and 334.

The user terminal 210 and the information processing system 230 may include more components than the components of FIG. 3. However, it is not necessary to clearly show most conventional components. According to an embodiment, the user terminal 210 may be implemented to include at least some of the above-described input/output devices 320. In addition, the user terminal 210 may further include other components such as a transceiver, a Global Positioning System (GPS) module, a camera, various sensors, a database, and so on. For example, if the user terminal 210 is a smartphone, the user terminal 210 may include components that a smartphone generally includes, and for example, various components such as an accelerometer sensor, a gyro sensor, a camera module, various physical buttons, buttons using a touch panel, input/output ports, a vibrator for vibration, and so on may be further included in the user terminal 210. According to an embodiment, the processor 314 of the user terminal 210 may be configured to operate an application or the like that provides a real-time video content generation service. At this time, code associated with the application and/or program may be loaded into the memory 312 of the user terminal 210.

While a program for a real-time video content generation application or the like is operating, the processor 314 may receive text, an image, a video, a voice, and/or a motion input or selected through an input device such as a touchscreen, a keyboard, a camera including an audio sensor and/or an image sensor, or a microphone connected to the input/output interface 318, and may store the received text, image, video, voice, and/or motion in the memory 312 or provide the received text, image, video, voice, and/or motion to the information processing system 230 via the communication module 316 and the network 220. For example, the processor 314 may receive a user input requesting the generation of text content based on a broadcast outline and provide the user input to the information processing system 230 via the communication module 316 and the network 220. As another example, the processor 314 may receive a user input indicating a request to modify reaction text and provide the user input to the information processing system 230 via the communication module 316 and the network 220.

The processor 314 of the user terminal 210 may be configured to manage, process, and/or store information and/or data received from the input device 320, another user terminal, the information processing system 230, and/or a plurality of external systems. Information and/or data processed by the processor 314 may be provided to the information processing system 230 via the communication module 316 and the network 220. The processor 314 of the user terminal 210 may transmit information and/or data to the input/output device 320 via the input/output interface 318 to output the information and/or data. For example, the processor 314 may display the received information and/or data on the screen of the user terminal.

The processor 334 of the information processing system 230 may be configured to manage, process, and/or store information and/or data received from a plurality of user terminals 210 and/or a plurality of external systems. Information and/or data processed by the processor 334 may be provided to the user terminal 210 via the communication module 336 and the network 220. According to an embodiment, the information processing system 230 may generate text content based on a broadcast outline received from a user terminal 210 (for example, an administrator terminal). Then, the information processing system 230 may generate a video including a voice and a view based on the text content, and may transmit the generated video to a plurality of user terminals 210 (for example, viewer terminals) in a real-time streaming manner.

Additionally, the information processing system 230 may generate reaction text for a received viewer's real-time chat, and may include a voice speaking the reaction text in the video. In addition, the information processing system 230 may transmit the video including the voice speaking the reaction text to a plurality of user terminals 210 in a real-time streaming manner.

The processor 334 of the information processing system 230 may be configured to output processed information and/or data through an output device 320 such as a display-output-capable device (e.g., a touchscreen, a display, etc.) or a voice-output-capable device (e.g., a speaker) of the user terminal 210. For example, the processor 334 of the information processing system 230 may be configured to provide a generated video to a user terminal 210 via the communication module 336 and the network 220, and to output the video through a display-output-capable device and a sound-output-capable device of the user terminal 210.

FIG. 4 is a block diagram illustrating the internal configuration of a processor 334 of an information processing system according to an embodiment of the present disclosure. FIG. 4 is only an example of the internal configuration of the processor 334 and does not show only the essential components of the processor 334, so the processor 334 may be configured differently according to embodiments. For example, other components may be additionally included in addition to the shown configuration, or some of the shown components may be omitted, and some of the shown components may be included in another device (for example, a processor of a user terminal). In addition, although the processor 334 is shown as a single processor in FIG. 4, the present disclosure is not limited thereto, and the processor 334 may be composed of a plurality of processors.

According to an embodiment, the processor 334 of the information processing system may include a content generation unit 410, a reaction text generation unit 420, a transmission control unit 430, a voice generation unit 440, a view generation unit 450, and a video transmission unit 460.

The content generation unit 410 may generate text content based on a broadcast outline. Here, the broadcast outline may be one input by an administrator through an administrator terminal, one generated based on an information collection result using the web, or one generated/modified based on a viewer's real-time chat. In addition, the broadcast outline may be a broadcast outline of various modalities. The content generation unit 410 may generate text content using a separate content generator that is configured differently or trained differently, depending on the type or format of the broadcast outline.

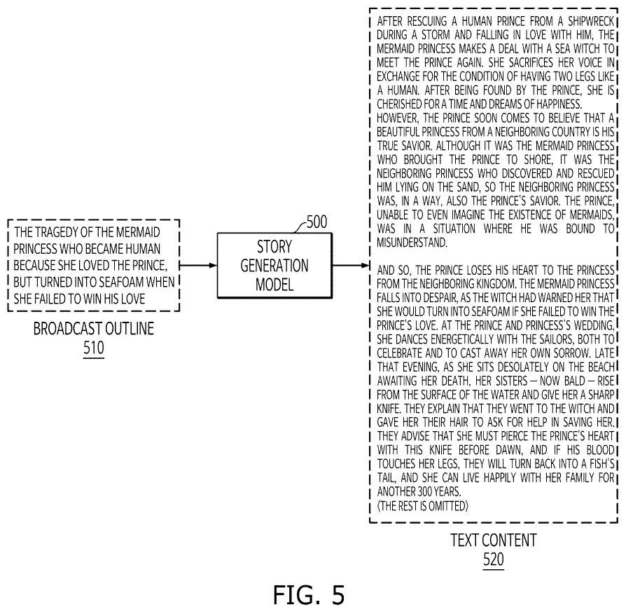

For example, the broadcast outline may be a broadcast outline of an arbitrary format input by an administrator. In this case, the content generation unit 410 may generate text content for a story broadcast based on the broadcast outline using a story generation model. This will be described in more detail later with reference to FIG. 5.

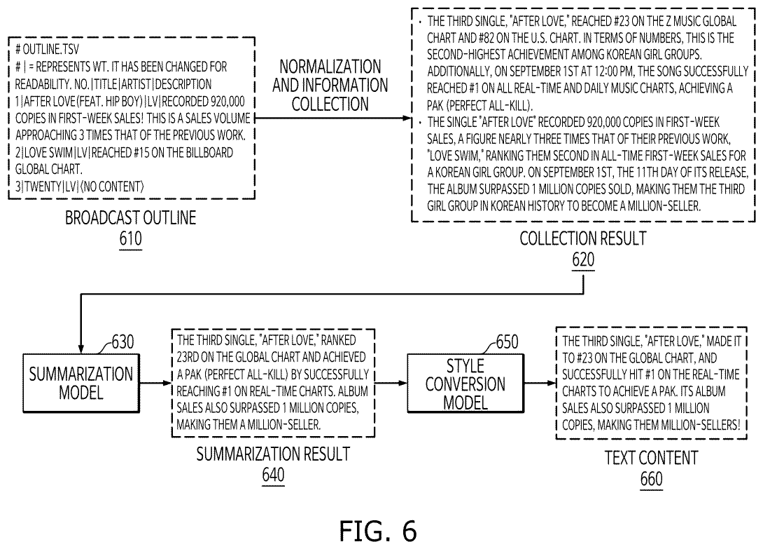

As another example, the broadcast outline may include a song list in a text format including a plurality of song titles input by an administrator. In this case, the content generation unit 410 may generate text content for a music broadcast based on the broadcast outline using a search engine, a summarization model, a style conversion model, and so on. This will be described in more detail later with reference to FIG. 6.

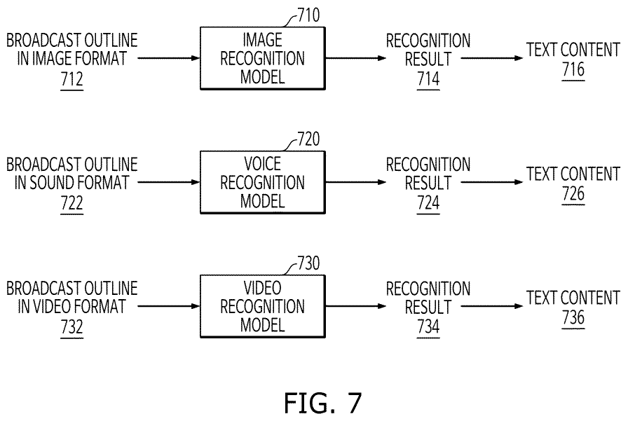

As yet another example, the broadcast outline may be at least one of a broadcast outline in an image format, a broadcast outline in a sound format, or a broadcast outline in a video format input by an administrator. The content generation unit 410 may generate text content based on the broadcast outline using an image recognition model, a voice recognition model, a video recognition model, and so on, depending on the modality of the broadcast outline. This will be described in more detail later with reference to FIG. 7.

According to an embodiment, the broadcast outline may be one that is automatically generated based on an information collection result (for example, a crawling result) using the web. For example, the broadcast outline may be one that is generated based on a collection result of collecting popular search term information using a web that provides at least one of a popular search term service or a trend service. As another example, the broadcast outline may be one that is generated based on a collection result of collecting popular news information using a web that provides a news service. As yet another example, the broadcast outline may be one that is generated based on a collection result of collecting popular music information using a web that provides a popular music chart service. The process of collecting popular search term information, popular news information, popular music information, and so on using the web and/or the process of generating a broadcast outline based thereon may be performed by the content generation unit 410 and/or a user terminal (for example, an administrator terminal).

The content generation unit 410 may generate text content based on a broadcast outline generated based on collected information. The method of generating text content based on a broadcast outline generated based on collected information may be performed in the same/similar manner as the method of generating text content based on a broadcast outline input by an administrator. As an example, the content generation unit 410 may generate a broadcast outline or text content by summarizing at least a part of a collection result of collecting popular news information using a web that provides a news service, using a summarization model. As another example, the content generation unit 410 may generate a broadcast outline or text content by rephrasing at least a part of a collection result of collecting popular news information using a web that provides a news service, using a paraphrasing model.

According to an embodiment, broadcast content may be determined or modified based on a viewer's real-time chat regarding a video. For example, a broadcast outline may be generated or modified based on at least a part of a real-time chat. In this case, the content generation unit 410 may generate text content based on the generated/modified broadcast outline.

The reaction text generation unit 420 may generate reaction text for at least a part of viewers'real-time chats. For example, first, the reaction text generation unit 420 may filter the real-time chat using a hate-speech detection model configured to determine the harmfulness of input text. Then, the reaction text generation unit 420 may select one or more real-time chats from among the filtered real-time chats for which reaction text is to be generated. Then, the reaction text generation unit 420 may generate reaction text for the selected one or more real-time chats.

According to an embodiment, instead of simply generating a reaction to a chat based only on the chat, the reaction text generation unit 420 may generate reaction text associated with the broadcast content by considering the broadcast outline or the text content. A specific example of the reaction text generation unit 420 generating reaction text will be described in more detail later with reference to FIG. 8.

The transmission control unit 430 may construct a script based on the text content generated/modified by the content generation unit 410 and the reaction text generated by the reaction text generation unit 420. The transmission control unit 430 may construct a script including the text content and the reaction text by considering a transmission priority associated with the text content and a transmission priority associated with the reaction text.

According to an embodiment, for an immediate response to a viewer's real-time chat, the transmission control unit 430 may preferentially include the reaction text in the script. That is, the transmission priority associated with the reaction text may precede the transmission priority associated with the text content.

According to an embodiment, a viewer's real-time chat may include a donation chat associated with a donation and a general chat not associated with a donation. The transmission control unit 430 may preferentially include reaction text for the donation chat associated with a donation in the script. That is, among the reaction text, a transmission priority associated with reaction text for the donation chat may precede a transmission priority associated with reaction text for the general chat.

According to an embodiment, an administrator may modify the text content generated by the content generation unit 410, a transmission priority associated with the text content, the reaction text generated by the reaction text generation unit 420, and/or a transmission priority associated with the reaction text, through an administrator terminal. When the text content, the reaction text, and/or the transmission priority is modified by the administrator, the transmission control unit 430 may construct a script considering the matters modified by the administrator. A specific example of the transmission control unit 430 constructing a script based on text content and reaction text will be described in more detail later with reference to FIG. 9.

The voice generation unit 440 may generate a voice based on a script. Here, the voice may be a voice that speaks the script. For example, the voice generation unit 440 may generate a voice that speaks the script, using an arbitrary Text To Speech (TTS) model. According to an embodiment, an administrator may select voice characteristics (for example, gender, age, region, voice pitch, speech rate, personality, tone, etc.) of a virtual streamer through an administrator terminal. In this case, the voice generation unit 440 may generate a voice that speaks the script, reflecting the voice characteristics selected by the administrator.

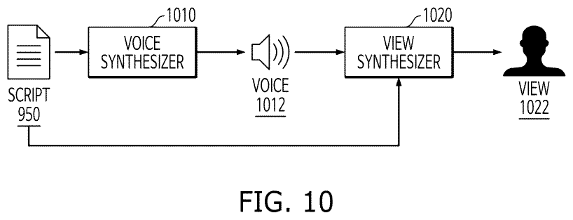

The view generation unit 450 may generate a view based on a script and/or a voice. Here, the view may include at least one of an appearance of a virtual streamer in a character form, an appearance of a virtual streamer in a virtual person form, or a background view associated with the text content. In an embodiment, when the view includes the appearance of a virtual streamer, the view may include a facial expression change of the virtual streamer, a mouth shape change of the virtual streamer, and/or a gesture of the virtual streamer. For example, the view generation unit 450 may generate a facial expression change of a virtual streamer reflecting an emotion associated with text content, using an emotion prediction model and a facial expression change model. Additionally or alternatively, the view generation unit 450 may generate a mouth shape change of a virtual streamer who is speaking a first voice, using a talking head model. Additionally or alternatively, the view generation unit 450 may generate a gesture of a virtual streamer using a gesture model. A specific example of the voice generation unit 440 and the view generation unit 450 generating a video including a voice and a view will be described in more detail later with reference to FIGS. 10 to 12.

The video transmission unit 460 may transmit a video including a voice and a view in a real-time streaming manner.

FIG. 5 illustrates an example of generating text content 520 based on a broadcast outline 510 using a story generation model 500 according to an embodiment of the present disclosure. According to an embodiment, an information processing system may generate text content 520 for a story broadcast based on a broadcast outline 510 using a story generation model 500. Here, the broadcast outline 510 may be one input by an administrator through an administrator terminal, one generated based on an information collection result using the web (for example, a crawling result of a website that provides a popular search term service, a trend service, or a news service, etc.), one generated or modified based on a viewer's real-time chat, or a combination of at least some of these.

According to an embodiment, the story generation model 500 may be a pre-trained language model (for example, a Transformer) or a model transfer-learned based on a pre-trained language model. For example, the story generation model 500 may be a model with an encoder-decoder structure trained to generate text content 520 based on a broadcast outline 510. In this case, the broadcast outline 510 (or a feature vector representing the broadcast outline 510, etc.) may be an input to an encoder of the story generation model 500, and the text content 520 may be predicted one unit (one word or one token, etc.) at a time in an autoregressive manner by a decoder of the story generation model 500.

According to an embodiment, an information processing system may convert a broadcast outline 510 into an input format that can be processed by a story generation model 500, using a tokenization module. For example, the broadcast outline 510 in a text format may be input to the story generation model 500 in a state of being tokenized into pre-defined tokens after passing through the tokenization module.

Additionally, the broadcast outline 510 may further include data of various modalities as well as data in a text format. For example, the broadcast outline 510 may further include data in at least one format of a sound format, a video format, or an image format, as well as data in a text format. In this case, a special token may be included in the input of the story generation model 500. For example, a compressed embedding vector obtained based on data of various modalities (for example, a sound format, a video format, an image format, etc.) may be included at the very beginning of the input of the story generation model 500. As a specific example, the special token may be a compressed vector obtained by vector quantizing a hidden representation sequence generated as a recognition result of a voice recognition model, a recognition result of a video recognition model, or a recognition result of an image recognition model.

The story generation model 500 may generate text content 520 based on an input (tokenized) broadcast outline 510. For example, the story generation model 500 may generate a tokenized output value based on the tokenized broadcast outline 510, and the tokenized output value may be converted into text content 520, which is data in a text form, through a detokenization process. In an embodiment, when a special token (for example, a compressed embedding vector) is included in the input of the story generation model 500, the story generation model 500 may generate the text content 520 by considering the special token.

The structure, inference method, and/or learning method of the story generation model 500 described above are only examples, and the story generation model 500 may be implemented differently from what has been described above or may be trained by a different method. For example, any story generation model 500 that can be adopted by a person of ordinary skill in the art may be used in the method for generating real-time video content.

FIG. 6 illustrates an example of generating text content 660 for a music broadcast based on a broadcast outline 610 including a plurality of song titles according to an embodiment of the present disclosure. According to an embodiment, an information processing system may generate text content 660 for a music broadcast based on a broadcast outline 610 including a song list in a text format that includes a plurality of song titles. For example, the broadcast outline 610 may be a song list including a sequence number, a title, an artist, and a description for each of a plurality of songs. In an embodiment, the broadcast outline 610 may be one input by an administrator through an administrator terminal, one generated based on an information collection result using the web (for example, a crawling result of a website that provides a popular music chart service, etc.), one generated or modified based on a viewer's real-time chat, or a combination of at least some of these.

As an example, first, an information processing system may normalize a broadcast outline 610 including a song list in a text format that includes a plurality of song titles. As a specific example, the information processing system may distinguish that ‘LV’ is an artist and ‘After LOVE’ is a song title from the song title ‘LV-After LOVE (feat. Hip boy)’, and may remove additional information such as featuring information. In an embodiment, when the broadcast outline 610 is already given in a normalized format, the information processing system may omit the normalization process.

Then, the information processing system may obtain a collection result 620 by collecting information based on the (normalized) broadcast outline 610 using the web. As a specific example, the information processing system may obtain the collection result 620 by crawling information about the songs included in the broadcast outline 610 using a search engine.

Then, the information processing system may generate a summarization result 640 by summarizing the collection result 620 using a summarization model 630. According to an embodiment, the summarization model 630 may be a model transfer-learned based on a pre-trained language model (for example, a Transformer). For example, the summarization model 630 may be a model with an encoder-decoder structure trained to generate text data of a summary based on text data of a long document to be summarized. In this case, the collection result 620 may be an input to an encoder of the summarization model 630, and the summarization result 640 may be predicted one unit (one word or one token, etc.) at a time in an autoregressive manner by a decoder of the summarization model 630. The structure, inference method, and/or learning method of the summarization model 630 described above are only examples, and the summarization model 630 may be implemented differently from what has been described above or may be trained by a different method. For example, any summarization model 630 that can be adopted by a person of ordinary skill in the art may be used in the method for generating real-time video content.

Additionally, the information processing system may generate text content 660 by changing the style of the summarization result 640 using a style conversion model 650. For example, the information processing system may generate the text content 660 by converting the summarization result 640 in a written style into a colloquial style with a friendly tone using the style conversion model 650. According to an embodiment, information about the style to be converted using the style conversion model 650 may be set by an administrator through an administrator terminal.

FIG. 7 illustrates an example of generating text content 716, 726, and 736 based on a broadcast outline 712, 722, and 732 of various modalities according to an embodiment of the present disclosure. According to an embodiment, an information processing system may generate text content 716, 726, and 736 based on a broadcast outline 712, 722, and 732 using an image recognition model 710, a voice recognition model 720, or a video recognition model 730, depending on the modality of the broadcast outline. A broadcast outline may include a broadcast outline in an image format 712, a broadcast outline in a sound format 722, or a broadcast outline in a video format 732. This broadcast outline 712, 722, 732 may be one input by an administrator through an administrator terminal, one obtained as a result of information collection using the web, or one collected based on a viewer's real-time chat.

As an example, an information processing system may generate text content 716 based on a broadcast outline in an image format 712 using an image recognition model 710. According to an embodiment, the image recognition model 710 may be a pre-trained image recognition model (for example, a Swin Transformer) or a model transfer-learned based on a pre-trained image recognition model. In an embodiment, the image recognition model 710 may be a model trained to predict an object included in an image based on the image.

As a specific example, an information processing system may first convert a broadcast outline in an image format 712 into an input format that can be processed by an image recognition model 710. For example, the information processing system may convert the broadcast outline in an image format 712 into a set of a plurality of patches (for example, a set of patches of 4 pixels by 4 pixels in size) and input the set of patches to the image recognition model 710. The image recognition model 710 may output a sequence of hidden representations as a recognition result 714 based on the input set of a plurality of patches. The information processing system may generate text content 716 based on the output recognition result 714.

As another example, an information processing system may generate text content 726 based on a broadcast outline in a sound format 722 using a voice recognition model 720. According to an embodiment, the voice recognition model 720 may be a pre-trained voice recognition model or a model transfer-learned based on a pre-trained voice recognition model. For example, the voice recognition model 720 may be a model of a transformer encoder-decoder series trained based on training data consisting of pairs of training voice and transcription data.

As a specific example, an information processing system may first convert a broadcast outline in a sound format 722 into an input format that can be processed by a voice recognition model 720. For example, the information processing system may convert the broadcast outline in a sound format 722 into a log scale spectrogram and input the log scale spectrogram to the voice recognition model 720. The voice recognition model 720 may output a sequence of hidden representations as a recognition result 724 based on the input spectrogram. For example, the voice recognition model 720 may predict the next token based on the token sequence predicted so far and output a sequence of hidden representations as the recognition result 724. The information processing system may generate text content 726 based on the output recognition result 724.

As yet another example, an information processing system may generate text content 736 based on a broadcast outline in a video format 732 using a video recognition model 730. According to an embodiment, the video recognition model 730 may be a model with a structure in which the time dimension of a pre-trained image recognition model (for example, a Swin Transformer) is extended. In an embodiment, the video recognition model 730 may be a model trained to predict an action, a motion, and so on included in a video based on the video.

As a specific example, an information processing system may first convert a broadcast outline in a video format 732 into an input format that can be processed by a video recognition model 730. For example, the information processing system may convert images included in the video from the broadcast outline in a video format 732 into a set of a plurality of patches (for example, a set of 4 pixel by 4 pixel by 1 patches in which a dimension representing time is added to a 4 pixel by 4 pixel patch) and input the set of patches to the video recognition model 730. The video recognition model 730 may output a sequence of hidden representations as a recognition result 734 based on the input set of a plurality of patches. The information processing system may generate text content 736 based on the output recognition result 734.

The process of the information processing system generating text content 716, 726, and 736 based on a recognition result 714 of the image recognition model 710, a recognition result 724 of the voice recognition model 720, or a recognition result 734 of the video recognition model 730 may be performed in a similar manner to that described above with reference to FIG. 5. For example, the information processing system may generate a compressed embedding vector by vector quantizing a sequence of hidden representations output as the recognition result 714, 724, and 734, and may generate the text content 716, 726, and 736 by including the compressed embedding vector in the input of a story generation model.

Additionally or alternatively, the information processing system may use the image recognition model 710, the voice recognition model 720, or the video recognition model 730 to generate reaction text. This will be described in detail later with reference to FIG. 8.

The structures, inference methods, and/or learning methods of the image recognition model 710, the voice recognition model 720, and the video recognition model 730 described above are only examples, and the models may be implemented differently from what has been described above or may be trained by different methods. For example, any image recognition model 710, voice recognition model 720, or video recognition model 730 that can be adopted by a person of ordinary skill in the art may be used in the method for generating real-time video content.

FIG. 8 illustrates an example of generating reaction text 836 for a viewer's real-time chat according to an embodiment of the present disclosure. An information processing system may generate reaction text 836 for at least a part of viewers'real-time chats.

First, the information processing system may acquire viewers'real-time chats for a video transmitted in a streaming manner. For example, the information processing system may acquire the viewers'real-time chats by crawling the viewers'real-time chats input to a video streaming platform. The received real-time chats may be accumulated in a chat queue 812.

According to an embodiment, the information processing system may filter the real-time chat using a hate-speech detection model 810 configured to determine the harmfulness of input text. For example, the information processing system may obtain a harmfulness probability 814 for each real-time chat by tokenizing the real-time chats included in the chat queue 812 using a tokenization module and inputting the tokenized chats to the hate-speech detection model 810. Then, the information processing system may determine a chat with a harmfulness probability 814 greater than or equal to/greater than a predefined threshold as a harmful chat, and may obtain a chat queue 822 from which harmful chats have been removed by removing the harmful chats from the chat queue.

Additionally or alternatively, the information processing system may determine a real-time chat 832 associated with broadcast content from among the real-time chats as a chat for which reaction text is to be generated. For example, the information processing system may obtain a similarity 824 for each real-time chat by inputting the real-time chats included in the (harmful-chat-removed) chat queue 822 to a similarity measurement model 820, and may select the real-time chat 832 associated with the broadcast content based on the similarity 824. Here, the similarity 824 may be a similarity between the real-time chat and the broadcast content, and in this case, not only the real-time chat but also broadcast content information 834 (for example, a broadcast outline, text content, and/or at least a part of these (summary, keywords, etc.), etc.) may be input together to the similarity measurement model 820. As a specific example, the information processing system may input the real-time chat included in the (harmful-chat-removed) chat queue 822 and the broadcast content information 834 to the similarity measurement model 820. Here, the similarity measurement model 820 may be a model of a transformer encoder series and may be a model trained through supervised contrastive learning. In addition, the real-time chat and the broadcast content information 834 may be input to the similarity measurement model 820 in a tokenized form through a tokenization module. The similarity measurement model 820 may output a similarity 824 (for example, a cosine similarity with a value between −1 and 1) between the input real-time chat and the broadcast content information 834. The information processing system may select the real-time chat with the highest similarity 824 as the real-time chat 832 associated with the broadcast content.

The information processing system may generate reaction text 836 for the real-time chat using a content chatbot 830. For example, the information processing system may generate the reaction text 836 based on the real-time chat 832 associated with the broadcast content, using the content chatbot 830. According to an embodiment, the content chatbot 830 may be a pre-trained language model (for example, a Transformer) or a model transfer-learned based on a pre-trained language model. For example, the content chatbot 830 may be a model with an encoder-decoder structure trained using multi-turn conversation data.

According to an embodiment, instead of simply generating reaction text based only on a chat, the information processing system may generate reaction text 836 associated with broadcast content by considering the broadcast content. For example, the information processing system may input the real-time chat 832 associated with the broadcast content and broadcast content information 834 (for example, a broadcast outline, text content, and/or at least a part of these (summary, keywords, etc.), etc.) to the content chatbot 830. Here, the real-time chat 832 associated with the broadcast content and the broadcast content information 834 may be input to the content chatbot 830 in a tokenized form through a tokenization module.

According to an embodiment, a viewer's real-time chat may include a chat of various modalities (for example, an image chat, a sound chat, and/or a video chat). In this case, a special token may be included in the real-time chat input to the content chatbot 830. For example, a compressed embedding vector obtained based on data of various modalities (for example, an image format, a sound format, a video format, etc.) may be included at the very beginning of the (tokenized) real-time chat 832 input to the content chatbot 830. As a specific example, the special token may be a compressed vector obtained by vector quantizing a hidden representation sequence generated as a recognition result of a voice recognition model, a recognition result of a video recognition model, or a recognition result of an image recognition model. Here, the voice recognition model, the video recognition model, and the image recognition model may be the same/similar models as those described above with reference to FIG. 7.

The content chatbot 830 may generate reaction text 836 for the real-time chat 832 by considering the broadcast content information 834. For example, the content chatbot 830 may generate a tokenized output value based on the tokenized real-time chat, and the tokenized output value may be converted into reaction text 836, which is data in a text form, through a detokenization process. In an embodiment, when a special token (for example, a compressed embedding vector) is included in the input of the content chatbot 830, the content chatbot 830 may generate the reaction text 836 by considering the special token.

The structures, inference methods, and/or learning methods of the hate-speech detection model 810, the similarity measurement model 820, and the content chatbot 830 described above are only examples, and the models may be implemented differently from what has been described above or may be trained by different methods. For example, any hate-speech detection model 810, similarity measurement model 820, or content chatbot 830 that can be adopted by a person of ordinary skill in the art may be used in the method for generating real-time video content.

FIG. 9 illustrates an example of generating a script 950 based on text content 910 and reaction text 920 and 930 according to an embodiment of the present disclosure. An information processing system may construct a script 950 based on text content 910 and reaction text 920 and 930. According to an embodiment, the information processing system may construct a script 950 including the text content 910 and the reaction text 920 and 930 by considering a transmission priority associated with the text content 910 and a transmission priority associated with the reaction text 920 and 930. Due to the characteristics of real-time video content, a viewer's real-time chat may be continuously received, and reaction text may also be continuously generated. Therefore, the information processing system may perform the task of continuously constructing/updating the script 950.

For example, the information processing system may construct a tuple list 940 based on text content 910, a first reaction text 920, and a second reaction text 930, using a stream controller 900. The tuple list 940 may include a plurality of tuples, and each tuple may include text (the text content 910 or the reaction text 920, 930) and a transmission priority. The information processing system may construct a script 950 based on the tuple list 940.

According to an embodiment, for an immediate response to a viewer's real-time chat, the information processing system may preferentially include the reaction text 920 and 930 in the script 950. That is, the transmission priorities associated with the reaction text 920 and 930 (1 and 0, respectively, in the example of FIG. 9) may precede the transmission priority associated with the text content 910 (2 in the example of FIG. 9).

Additionally or alternatively, a viewer's real-time chat may include a donation chat associated with a donation and a general chat not associated with a donation. The information processing system may preferentially include reaction text for the donation chat associated with a donation in the script 950. That is, among the reaction text 920 and 930, a transmission priority associated with reaction text for the donation chat (the second reaction text 930 in the example of FIG. 9) (0 in the example of FIG. 9) may precede a transmission priority associated with reaction text for the general chat (the first reaction text 920 in the example of FIG. 9) (1 in the example of FIG. 9).

According to an embodiment, the text content 910, the reaction text 920 and 930, the tuple list 940, and/or the script 950 may be output to an administrator terminal. The administrator may modify the text content 910, a transmission priority associated with the text content 910, the reaction text 920 and 930, a transmission priority associated with the reaction text 920 and 930, and/or the script 950 through the administrator terminal. When the text content 910, the reaction text 920 and 930, and/or the transmission priority are modified by the administrator, the information processing system may reconstruct the script 950 by considering the matters modified by the administrator.

The script construction method described above is only an example of the present disclosure, and a script 950 for video content may be constructed by other methods. For example, a script 950 including a plurality of text content items (for example, each sentence of the text content is configured as a respective text content item) may be constructed. The information processing system may update the script 950 by adding reaction text to an appropriate position in the script 950 (for example, between two specific text content items) each time reaction text is generated or periodically.

FIG. 10 illustrates an example of generating a voice 1012 based on a script 950 and generating a view 1022 based on the script 950 and/or the voice 1012 according to an embodiment of the present disclosure. An information processing system may generate a voice 1012 based on a script 950. Here, the voice 1012 may be a voice that speaks the script 950. For example, the information processing system may generate a voice 1012 that speaks the script, based on the script 950, using a voice synthesizer 1010 (for example, an arbitrary voice synthesis (TTS) model, etc.).

According to an embodiment, an administrator may select voice characteristics (for example, gender, age, region, voice pitch, speech rate, personality, tone, etc.) of a virtual streamer through an administrator terminal. In this case, the information processing system may generate a voice 1012 that speaks the script 950, reflecting the voice characteristics selected by the administrator, using the voice synthesizer 1010.

Additionally, the information processing system may generate a view 1022 based on the script 950 and/or the voice 1012. For example, the information processing system may generate the view 1022 based on the script 950 and/or the voice 1012, using a view synthesizer 1020 (for example, an arbitrary video synthesis system, etc.). Here, the view 1022 may include at least one of an appearance of a virtual streamer in a character form (2D character or 3D character), an appearance of a virtual streamer in a virtual person form, or a background view associated with the text content.

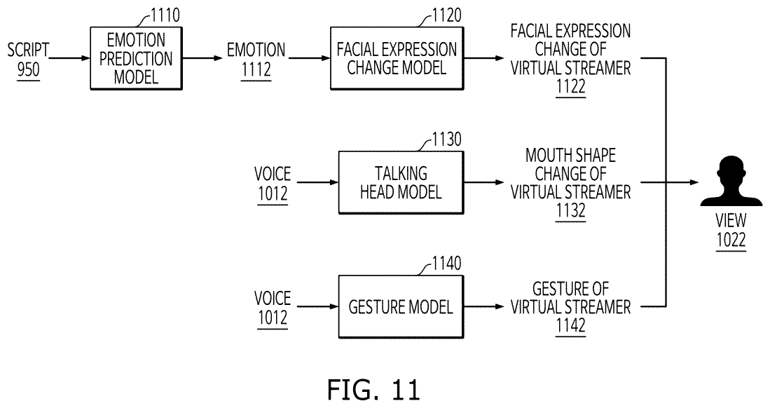

FIG. 11 illustrates an example of generating a view 1022 including a virtual streamer based on a script 950 and/or a voice 1012 according to an embodiment of the present disclosure. In an embodiment, when the view 1022 includes the appearance of a virtual streamer, the view 1022 may include a facial expression change 1122 of the virtual streamer, a mouth shape change 1132 of the virtual streamer, and/or a gesture 1142 of the virtual streamer.

According to an embodiment, the view 1022 may include a facial expression change 1122 of a virtual streamer that reflects an emotion 1112 associated with the script 950 and/or the voice 1012. An information processing system may generate the facial expression change 1122 of the virtual streamer that reflects the emotion 1112 associated with the script 950, using an emotion prediction model 1110 and a facial expression change model 1120.

For example, first, the information processing system may predict an emotion 1112 associated with a script 950 using an emotion prediction model 1110. Here, the emotion prediction model 1110 may be a model of a transformer encoder series trained to output an emotion label based on input text. The information processing system may input at least a part of the script to the emotion prediction model 1110. Here, at least a part of the script may be input to the emotion prediction model 1110 in a tokenized form through a tokenization module. The emotion prediction model 1110 may predict an emotion label based on at least a part of the (tokenized) script.

Then, the information processing system may generate a facial expression change 1122 of a virtual streamer based on the emotion 1112 using a facial expression change model 1120. Here, the facial expression change model 1120 may be a model trained to enable image manipulation for an input image based on a text prompt. The information processing system may input a reference image of the virtual streamer (for example, a basic face image of the virtual streamer) and the emotion 1112 (for example, an emotion label predicted by the emotion prediction model 1110) to the facial expression change model 1120. The facial expression change model 1120 may output an image of the virtual streamer with a changed facial expression based on the input emotion 1112, and the output image of the virtual streamer may be included in the view 1022 as the facial expression change 1122 of the virtual streamer.

Additionally or alternatively, the view 1022 may include a mouth shape change 1132 of a virtual streamer speaking a voice 1012. For example, the information processing system may generate the mouth shape change 1132 of the virtual streamer speaking the voice 1012 using a talking head model 1130. Here, the talking head model 1130 may be a model with a Generative Adversarial Network (GAN) structure trained to generate a video in which the mouth shape of a person included in an image changes to naturally speak an audio, based on the audio and the image including the person (an image in which the lower part of the person's face is masked). The information processing system may input the voice 1012 (for example, a voice speaking a script) and a reference image of the virtual streamer (for example, a basic face image of the virtual streamer) to the talking head model 1130. Here, the voice 1012 may be input in a form converted into a log scale spectrogram. The talking head model 1130 may generate a mouth shape change 1132 of the virtual streamer speaking the voice 1012, and the generated mouth shape change 1132 may be included in the view 1022.

Additionally or alternatively, the view 1022 may include a gesture 1142 of a virtual streamer associated with a voice 1012. For example, the information processing system may generate the gesture 1142 of the virtual streamer using a gesture model 1140. Here, the gesture model 1140 may include a voice encoder that generates a latent representation from the voice 1012 and a style encoder that learns a latent space from position information of an animation clip. The information processing system may input the voice 1012 (for example, a voice speaking a script 950) and a clip of a gesture animation to the gesture model 1140. Here, the voice 1012 may be input in a form converted into a log scale spectrogram. The gesture model 1140 may output a voice embedding based on the voice 1012 and may output a style embedding based on the clip of the gesture animation. The information processing system may implement the gesture 1142 of the virtual streamer based on the output voice embedding and style embedding. The implemented gesture 1142 of the virtual streamer may be included in the view 1022.

The structures, inference methods, and/or learning methods of the emotion prediction model 1110, the facial expression change model 1120, the talking head model 1130, and the gesture model 1140 described above are only examples, and the models may be implemented differently from what has been described above or may be trained by different methods. For example, any emotion prediction model 1110, facial expression change model 1120, talking head model 1130, or gesture model 1140 that can be adopted by a person of ordinary skill in the art may be used in the method for generating real-time video content.

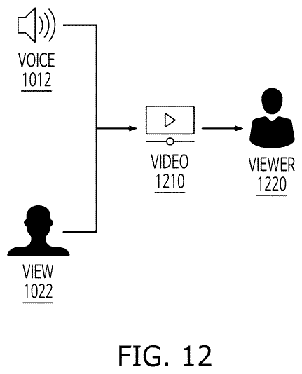

FIG. 12 illustrates an example of generating a video 1210 including a voice 1012 and a view 1022 and transmitting the video 1210 to a viewer 1220 according to an embodiment of the present disclosure. An information processing system may transmit a video 1210 including a voice 1012 that speaks a script and a view 1022 in a real-time streaming manner. According to an embodiment, the video 1210 may further include other sounds in addition to the voice 1012 that speaks the script. For example, the video 1210 may further include sounds such as background music, sound effects, and music included in a song list of a music broadcast.

A viewer 1220 may watch a video 1210 transmitted in a streaming manner through a viewer terminal. In addition, the viewer 1220 may react to the video 1210 by inputting a real-time chat through the viewer terminal. Here, the real-time chat may include various types of chats such as an image chat, a video chat, and a sound chat, as well as a text chat. In addition, the real-time chat may include a donation chat that includes a donation sent to a user account associated with the video 1210 (for example, a user account associated with an administrator) and a general chat that does not include a donation.

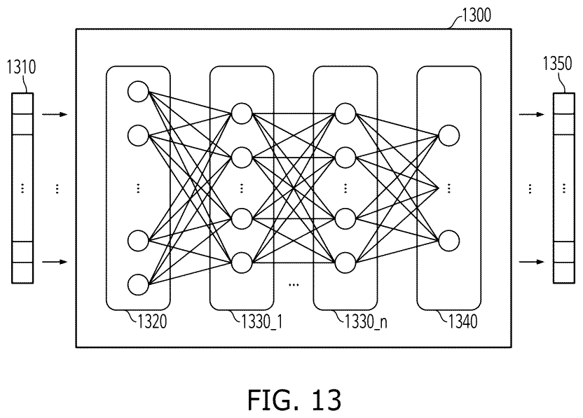

FIG. 13 is a diagram illustrating an artificial neural network model 1300 according to an embodiment of the present disclosure. The artificial neural network model 1300 is, as an example of a machine learning model, a statistical learning algorithm implemented based on the structure of a biological neural network, or a structure that executes that algorithm, in machine learning technology and cognitive science.

According to an embodiment, the artificial neural network model 1300 may represent a machine learning model that has problem-solving ability by learning in such a way that an error between a correct output corresponding to a specific input and an inferred output is reduced by nodes, which are artificial neurons that form a network through synaptic connections as in a biological neural network, repeatedly adjusting the weights of the synapses. For example, the artificial neural network model 1300 may include any probability model, neural network model, and so on used in artificial intelligence learning methods such as machine learning and deep learning.

According to an embodiment, the above-described content generator (for example, a story generation model, a summarization model, an image recognition model, a voice recognition model, a video recognition model, etc.), hate-speech detection model, similarity measurement model, content chatbot, voice synthesizer, view synthesizer (for example, an emotion prediction model, a facial expression change model, a talking head model, a gesture model, etc.), and so on may be implemented in the form of the artificial neural network model 1300.

The artificial neural network model 1300 may be composed of one or more layers of nodes and connections between the nodes. The artificial neural network model 1300 according to this embodiment may be implemented using one of various artificial neural network model structures including an MLP. As shown in FIG. 13, the artificial neural network model 1300 is composed of an input layer 1320 that receives an input signal or data 1310 from the outside, an output layer 1340 that outputs an output signal or data 1250 corresponding to the input data, and n (where n is a positive integer) hidden layers 1330_1 to 1330_n that are located between the input layer 1320 and the output layer 1340 and receive a signal from the input layer 1320, extract features, and deliver the features to the output layer 1340. Here, the output layer 1340 receives a signal from the hidden layers 1330_1 to 1330_n and outputs the signal to the outside.

The learning methods of the artificial neural network model 1300 include a supervised learning method that learns to be optimized for solving a problem by the input of a teacher signal (correct answer), and an unsupervised learning method that does not require a teacher signal. The artificial neural network model 1300 may be trained by a method that is the same as/similar to the learning method described above with reference to FIGS. 5 to 8, 10, and 11.

According to an embodiment, when the artificial neural network model 1300 is a story generation model, an input variable may include a vector representing or characterizing a broadcast outline in a text format. When the input variable described above is input through the input layer 1320 in this way, an output variable output from the output layer 1340 may be a vector representing or characterizing text content.

In addition, when the artificial neural network model 1300 is a voice synthesizer, an input variable may include a vector representing or characterizing a script. When the input variable described above is input through the input layer 1320 in this way, an output variable output from the output layer 1340 of the artificial neural network model 1300 may be a vector representing or characterizing a synthesized voice.

In this way, a plurality of output variables corresponding to a plurality of input variables are respectively matched to the input layer 1320 and the output layer 1340 of the artificial neural network model 1300, and by adjusting the synapse values between the nodes included in the input layer 1320, the hidden layers 1330_1 to 1330_n, and the output layer 1340, the model may be trained to extract a correct output corresponding to a specific input. Through this learning process, the characteristics hidden in the input variables of the artificial neural network model 1300 can be identified, and the synapse values (or weights) between the nodes of the artificial neural network model 1300 can be adjusted so that the error between an output variable calculated based on the input variables and a target output is reduced. Using the artificial neural network model 1300 trained in this way, text content may be generated, reaction text may be generated, or a voice and a view may be synthesized.

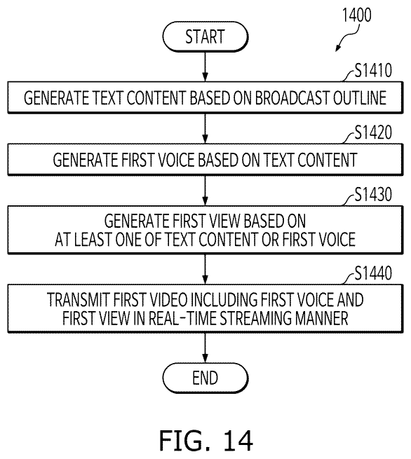

FIG. 14 is a flowchart illustrating an example of a method for generating real-time video content 1400 according to an embodiment of the present disclosure. According to an embodiment, the method for generating real-time video content 1400 may be initiated by a processor (for example, at least one processor of an information processing system) generating text content based on a broadcast outline (S1410).

The processor may generate text content based on a broadcast outline of various modalities. For example, the processor may generate text content based on a broadcast outline in a text format, a broadcast outline in a sound format, a broadcast outline in an image format, a broadcast outline in a video format, and so on.

For example, the processor may generate text content based on a broadcast outline in a text format using a story generation model. As another example, a broadcast outline is a song list including a plurality of song titles, and the processor may normalize the plurality of song titles and collect information associated with a plurality of songs included in the song list based on the normalized plurality of song titles using a search engine. Then, the processor may generate text content by summarizing the collected information using a summarization model and changing the style of the summarized information using a style conversion model. As yet another example, the processor may generate text content based on a broadcast outline in an image format using an image recognition model, generate text content based on a broadcast outline in a sound format using a voice recognition model, or generate text content based on a broadcast outline in a video format using a video recognition model.

According to an embodiment, a broadcast outline may be given by a user (for example, an administrator) or may be one generated based on an information collection result (for example, a crawling result) using the web. For example, the broadcast outline may be one generated based on a collection result of collecting popular search term information using a web that provides at least one of a popular search term service or a trend service. As another example, the broadcast outline may be one generated based on a collection result of collecting popular news information using a web that provides news. The process of collecting popular search term information or popular news information using the web and/or the process of generating a broadcast outline based thereon may be performed by an information processing system and/or a user terminal (for example, an administrator terminal).

Then, the processor may generate a first voice based on the text content (S1420). Here, the first voice may include a voice that speaks the generated text content. For example, the processor may generate the first voice from the text content using an arbitrary voice synthesis model.

In addition, the processor may generate a first view based on at least one of the text content or the first voice (S1430). According to an embodiment, the first view may include at least one of a virtual streamer in a character form, a virtual streamer in a virtual person form, or a background view associated with the text content.

When the first view includes a virtual streamer, the first view may include a facial expression change of the virtual streamer, a mouth shape change of the virtual streamer, and/or a gesture of the virtual streamer. According to an embodiment, the facial expression change of the virtual streamer may be a facial expression change of the virtual streamer that reflects an emotion associated with the text content, and the facial expression change may be generated using an emotion prediction model and a facial expression change model. Additionally or alternatively, the mouth shape change of the virtual streamer may be a mouth shape change of the virtual streamer who is speaking the first voice, and the mouth shape change may be generated using a talking head model. Additionally or alternatively, the gesture of the virtual streamer may be generated using a gesture model.

The processor may transmit a first video including the first voice and the first view in a real-time streaming manner (S1440). A viewer may watch the first video broadcast in a real-time streaming manner using a viewer terminal and may transmit a real-time chat regarding the first video. The processor may acquire real-time chats regarding the first video from a plurality of viewer terminals.

According to an embodiment, the processor may generate reaction text for at least a part of a real-time chat using a chatbot model. For example, the processor may generate reaction text associated with broadcast content for at least a part of the real-time chat based on a broadcast outline or text content, using the chatbot model.

According to an embodiment, the processor may generate reaction text for a chat with a high degree of association with broadcast content among real-time chats. For example, the processor may select one or more real-time chats associated with broadcast content from among the real-time chats using a similarity measurement model. Then, the processor may generate reaction text for the selected one or more real-time chats using a chatbot model.

According to an embodiment, a viewer's real-time chat may include a chat of various modalities (for example, a text chat, an image chat, a sound chat, and/or a video chat), and the processor may generate reaction text for the chat of various modalities using a chatbot model.

According to an embodiment, before generating reaction text for a real-time chat, the processor may filter the real-time chat using a hate-speech detection model configured to determine the harmfulness of input text.

Then, the processor may generate a second voice based on the text content and the reaction text. For example, the processor may generate the second voice using a transmission priority associated with the text content and a transmission priority associated with the reaction text. The second voice may include a voice that speaks the text content and the reaction text according to the transmission priority. In addition, the processor may generate a second view based on at least one of the text content or the second voice, and may transmit a second video including the second voice and the second view in a real-time streaming manner.

In an embodiment, when reaction text for a viewer's real-time chat is generated, the processor may preferentially read out the reaction text. That is, according to an embodiment, a transmission priority associated with the reaction text may precede a transmission priority associated with the text content.

Additionally or alternatively, a viewer's real-time chat may include a donation chat associated with a donation and a general chat not associated with a donation. In this case, the processor may preferentially read out reaction text for the donation chat associated with a donation. That is, among the reaction text, a transmission priority associated with reaction text for the donation chat may precede a transmission priority associated with reaction text for the general chat.

According to an embodiment, the processor may modify broadcast content based on a viewer's real-time chat for a first video transmitted in a real-time streaming manner. For example, a broadcast outline may be modified based on at least a part of a real-time chat. The processor may generate modified text content based on the modified broadcast outline using a story generation model, may generate a third voice and a third view based on the modified text content, and may transmit a third video including the third voice and the third view in a real-time streaming manner.

The flowchart included in the drawings and the above description are only examples, and the scope of the present disclosure is not limited thereto. For example, according to other embodiments, some steps may be added/changed/deleted, and the order of each step may be changed.

The method described above may be provided as a computer program stored in a computer-readable recording medium for execution on a computer. The medium may be one that continuously stores a computer-executable program or one that temporarily stores a program for execution or download. In addition, the medium may be various recording means or storage means in the form of a single piece of hardware or a combination of several pieces of hardware, and is not limited to a medium directly connected to a certain computer system, but may also be one distributed over a network. Examples of the medium may include a magnetic medium such as a hard disk, a floppy disk, and a magnetic tape, an optical recording medium such as a CD-ROM and a DVD, a magneto-optical medium such as a floptical disk, and one configured to store program instructions, including a ROM, a RAM, a flash memory, and so on. In addition, other examples of the medium may include a recording medium or a storage medium managed by an app store that distributes applications or a site, a server, and so on that supply or distribute various other software.

The methods, operations, or techniques of the present disclosure may be implemented by various means. For example, the techniques may be implemented by hardware, firmware, software, or a combination thereof. Those skilled in the art will understand that the various illustrative logical blocks, modules, circuits, and algorithm steps described in connection with the disclosure can be embodied as electronic hardware, computer software, or combinations thereof. To clearly illustrate this interchangeability, various illustrative components, blocks, modules, circuits, and steps have been described above generally in terms of their functionality. Whether the functionality is implemented as hardware or software depends upon the particular application and design constraints imposed on the overall system. Implementations described as hardware may be substituted by corresponding software implementations and vice versa, without departing from the scope of the disclosure.

In a hardware implementation, processing units used to perform the techniques may be implemented within one or more ASICs, DSPs, digital-signal-processing devices, programmable logic devices, field-programmable gate arrays, processors, controllers, microcontrollers, microprocessors, electronic devices, other electronic units designed to perform the functions described herein, computers, or combinations thereof.

Thus, various illustrative logical blocks, modules, and circuits described in connection with the disclosure may be implemented or performed within a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, for example, a combination of a DSP and a microprocessor, multiple microprocessors, one or more microprocessors in conjunction with a DSP core, or any other such configuration.

In a firmware and/or software implementation, the techniques may be implemented as instructions stored on computer-readable media such as random access memory (RAM), read-only memory (ROM), non-volatile RAM (NVRAM), programmable read-only memory (PROM), erasable programmable read-only memory (EPROM), electrically erasable PROM (EEPROM), flash memory, compact discs (CD), magnetic or optical data storage devices, etc. The instructions may be executable by one or more processors to cause the processor(s) to perform certain aspects of the functions described in this disclosure.

When implemented in software, the techniques described above may be stored on or transmitted over a computer-readable medium as one or more instructions or code. Computer-readable media include both computer-storage media and communication media that facilitate transfer of a computer program from one place to another. Storage media may be any available media that can be accessed by a computer. By way of example, and not limitation, computer-readable media can comprise RAM, ROM, EEPROM, CD-ROM or other optical-disk storage, magnetic-disk storage or other magnetic storage devices, or any other medium that can be used to carry or store desired program code in the form of instructions or data structures and that can be accessed by a computer. Also, any connection is properly termed a computer-readable medium.

For example, if the software is transmitted from a website, server, or other remote source over coaxial cable, fiber-optic cable, twisted-pair, digital-subscriber-line (DSL), or wireless technologies such as infrared, radio, and microwave, then coaxial cable, fiber-optic cable, twisted-pair, DSL, or infrared, radio, and microwave are included in the definition of a medium. As used herein, disks and discs include compact discs (CDs), laser discs, optical discs, digital versatile discs (DVDs), floppy disks, and Blu-ray discs, wherein disks reproduce data magnetically and discs reproduce data optically with lasers. Combinations of the above are also included within the scope of computer-readable media.

Software modules may reside in RAM memory, flash memory, ROM memory, EPROM memory, EEPROM memory, registers, hard disks, removable disks, CD-ROMs, or any other form of recording medium known in the art. An exemplary recording medium may be coupled to a processor such that the processor can read information from, and write information to, the recording medium. Alternatively, the recording medium may be integral to the processor. The processor and the recording medium may reside in an ASIC, which may be part of a user terminal. Alternatively, the processor and the recording medium may reside as distinct components in a user terminal.

Although the embodiments described above have been described in the context of standalone computer systems utilizing aspects of the disclosed subject matter, the disclosure is not so limited, and may be implemented in any computing environment, such as a network or distributed computing environment. Furthermore, aspects of the subject matter described herein may be implemented on multiple processing chips or devices, and storage may similarly be affected across multiple devices. Such devices may include PCs, network servers, and portable devices.

While the disclosure has been described with reference to certain embodiments, various modifications and changes may be made without departing from the scope of the disclosure as is apparent to those skilled in the art. Such modifications and changes are intended to fall within the scope of the appended claims.

1. A method of generating real-time video content, performed by at least one processor, the method comprising:
generating text content based on a broadcast outline;
generating a first voice based on the text content;
generating a first view based on at least one of the text content or the first voice; and
transmitting a first video comprising the first voice and the first view in a real-time streaming manner.

2. The method as claimed in claim 1, further comprising:
acquiring a viewer's real-time chat for the first video transmitted in the real-time streaming manner; and
generating reaction text for at least a part of the real-time chat using a chatbot model.

3. The method as claimed in claim 2, further comprising:
generating a second voice based on the text content and the reaction text;
generating a second view based on at least one of the text content or the second voice; and
transmitting a second video comprising the second voice and the second view in the real-time streaming manner.

4. The method as claimed in claim 2, wherein the generating of the reaction text for at least a part of the real-time chat comprises:
generating, using the chatbot model, reaction text associated with broadcast content for at least a part of the real-time chat, based on the broadcast outline or the text content.

5. The method as claimed in claim 2, wherein the generating of the reaction text for at least a part of the real-time chat comprises:
selecting one or more real-time chats associated with broadcast content from the real-time chat using a similarity measurement model; and
generating the reaction text for the selected one or more real-time chats using the chatbot model.

6. The method as claimed in claim 2, further comprising:
filtering the real-time chat using a hate-speech detection model configured to determine harmfulness of input text.

7. The method as claimed in claim 2, wherein the viewer's real-time chat comprises at least one of a text chat, an image chat, a sound chat, or a video chat.

8. The method as claimed in claim 3, wherein the generating of the second voice based on the text content and the reaction text comprises:
generating the second voice using a transmission priority associated with the text content and a transmission priority associated with the reaction text.

9. The method as claimed in claim 8, wherein the viewer's real-time chat comprises a donation chat associated with a donation and a general chat not associated with a donation,
the transmission priority associated with the reaction text precedes the transmission priority associated with the text content, and
among the reaction text, a transmission priority associated with reaction text for the donation chat precedes a transmission priority associated with reaction text for the general chat.

10. The method as claimed in claim 1, wherein the generating of the text content based on the broadcast outline comprises: generating the text content based on a broadcast outline in a text format using a story generation model.

11. The method as claimed in claim 1, wherein the broadcast outline is a song list comprising a plurality of song titles, and
the generating of the text content based on the broadcast outline comprises:
normalizing the plurality of song titles;
collecting information associated with a plurality of songs included in the song list based on the normalized plurality of song titles using a search engine;
summarizing the collected information using a summarization model; and
changing a style of the summarized information using a style conversion model.

12. (canceled)

13. The method as claimed in claim 1, wherein the broadcast outline is generated based on a collection result of collecting popular news information using a web that provides news.

14. The method as claimed in claim 1, wherein the generating of the text content based on the broadcast outline comprises generating, using an image recognition model, the text content based on a broadcast outline in an image format.

15. The method as claimed in claim 1, wherein the generating of the text content based on the broadcast outline comprises generating, using a voice recognition model, the text content based on a broadcast outline in a sound format.

16. The method as claimed in claim 1, wherein the generating of the text content based on the broadcast outline comprises generating, using a video recognition model, the text content based on a broadcast outline in a video format.

17. The method as claimed in claim 1, further comprising:
acquiring a viewer's real-time chat for the first video transmitted in the real-time streaming manner;
modifying the broadcast outline based on at least a part of the real-time chat;
generating modified text content based on the modified broadcast outline using a story generation model;
generating a third voice and a third view based on the modified text content; and
transmitting a third video comprising the third voice and the third view in a real-time streaming manner.

18. The method as claimed in claim 1, wherein the first view comprises at least one of a virtual streamer in a character form, a virtual streamer in a virtual person form, or a background view associated with the text content.

19. The method as claimed in claim 1, wherein the first view comprises a virtual streamer in a character form or a virtual person form, and
the generating of the first view based on at least one of the text content or the first voice comprises generating the first view comprising a facial expression change of the virtual streamer reflecting an emotion associated with the text content, using an emotion prediction model and a facial expression change model.

20. The method as claimed in claim 1, wherein the first view comprises a virtual streamer in a character form or a virtual person form, and
the generating of the first view based on at least one of the text content or the first voice comprises generating the first view comprising a mouth shape change of the virtual streamer, who is speaking the first voice, using a talking head model.

21. The method as claimed in claim 1, wherein the first view comprises a virtual streamer in a character form or a virtual person form, and
the generating of the first view based on at least one of the text content or the first voice comprises generating the first view comprising a gesture of the virtual streamer using a gesture model.

22. (canceled)

23. (canceled)
